(19) United States
(12) Patent Application Publication
(10) Pub. No.: US 2024/0109371 A1
(43) Pub. Date: Apr. 4, 2024

(54) TIRE

(71) Applicant: Sumitomo Rubber Industries, Ltd., Hyogo (JP)

(72) Inventors: Akira MINAGOSHI, Kobe-shi (JP); Dong MIAO, Kobe-shi (JP)

(73) Assignee: Sumitomo Rubber Industries, Ltd., Hyogo (JP)

(21) Appl. No.: 17/767,406

(22) PCT Filed: Oct. 26, 2020
(86) PCT No.: PCT/JP2020/040124

§ 371 Date: Apr. 7, 2022

(30) Foreign Application Priority Data
Oct. 29, 2019 (JP) 2019-196461

(51) Int. Cl. B60C 9/00; B60C 9/18; B60C 9/20; B60C 11/00

(52) U.S. Cl. CPC B60C 9/0064; B60C 9/0007; B60C 9/18; B60C 9/20; B60C 11/0008; B60C 2009/0021; B60C 2009/2064; B60C 2009/2077; B60C 2009/2083; B60C 2011/0033

(57) ABSTRACT

A belt layer includes at least one belt ply. The belt ply includes a single-wire cord having a short diameter SD and a long diameter LD, with a ratio SD/LD between the short diameter SD and the long diameter LD being less than 1.00, and a topping rubber covering the single-wire cord. The single-wire cord is arranged so that a direction of the short diameter SD is oriented to a thickness direction of the belt ply. The topping rubber has a complex elastic modulus (E*) of less than 7 MPa under conditions of temperature of 70 degrees Celsius, initial strain of 10%, an amplitude of dynamic strain of ±1.0%, and a frequency of 10 Hz.

### TECHNICAL FIELD

The present invention relates to tires in which flat single-wire cords are used.

### BACKGROUND ART

Conventionally, tires in which flat single-wire cords are used in a belt ply have been proposed (for example, see Patent Document 1).

### PRIOR ART DOCUMENT

Patent Document
Patent Document 1: Japanese Unexamined Patent Application Publication No. 2018-58515

### SUMMARY OF INVENTION

### Problems to be Solved by Invention

In the above-mentioned belt ply, topping rubber can be easily formed thin, which contributes to reduction in weight and improvement in fuel efficiency performance.

However, due to the reduction in thickness of the topping rubber, it is possible that noise performance and ride comfort performance are degraded.

The present invention was made in view of the above, and a primary object thereof is to provide a tire with the noise performance and the ride comfort performance improved in a good balance and with the reduction in weight and the fuel-efficiency performance improved in a good balance.

### Means for Solving Problem

The present invention is a tire having a belt layer disposed inside a tread portion, wherein the belt layer includes at least one belt ply, the at least one belt ply includes a single-wire cord having a short diameter SD and a long diameter LD, with a ratio SD/LD between the short diameter SD and the long diameter LD being less than 1.00, and a topping rubber covering the single-wire cord, the single-wire cord is arranged so that a direction of the short diameter SD is oriented to a thickness direction of the at least one belt ply, and the topping rubber has a complex elastic modulus (E*) of less than 7 MPa under conditions of temperature of 70 degrees Celsius, initial strain of 10%, an amplitude of dynamic strain of ±1.0%, and a frequency of 10 Hz.

In the tire according to the present invention, it is preferred that the complex elastic modulus (E*) is 5 MPa or less.

In the tire according to the present invention, it is preferred that the complex elastic modulus (E*) is 3 MPa or more.

In the tire according to the present invention, it is preferred that the short diameter SD is 0.15 mm to 0.42 mm.

In the tire according to the present invention, it is preferred that the short diameter SD is 0.20 mm to 0.35 mm.

In the tire according to the present invention, it is preferred that the ratio SD/LD of the single-wire cord is 0.70 or less.

In the tire according to the present invention, it is preferred that the ratio SD/LD of the single-wire cord is 0.50 or less.

In the tire according to the present invention, it is preferred that the belt layer has a plurality of the belt plies.

In the tire according to the present invention, it is preferred that a distance D between the single-wire cords between the plurality of the belt plies is 0.30 mm to 1.05 mm.

In the tire according to the present invention, it is preferred that the distance D is 0.50 mm to 0.80 mm.

In the tire according to the present invention, it is preferred that a difference D-SD between the distance D and the short diameter SD is 0.20 mm to 0.45 mm.

In the tire according to the present invention, it is preferred that the difference D-SD is 0.25 mm to 0.40 mm.

In the tire according to the present invention, it is preferred that the tread portion has a tread rubber having a groove provided in an outer surface thereof, and a minimum rubber thickness from a bottom of the groove to the single-wire cord is 1.0 mm to 4.0 mm.

In the tire according to the present invention, it is preferred that the minimum rubber thickness is 2.0 mm to 3.0 mm.

### Advantageous Effects of Invention

The tire of the present invention has the flat single-wire cord and the topping rubber included in the belt ply, and the single-wire cord is arranged so that the direction of the short diameter SD is oriented to the thickness direction of the belt ply. Therefore, the thickness of the unvulcanized belt ply can be suppressed, thereby, reduction in weight of the tire can be achieved, and thus the fuel-efficiency performance is improved. Further, since the complex elastic modulus (E*) of the topping rubber is less than 7 MPa, bending rigidity of the belt ply is suppressed, therefore, the noise performance and the ride comfort performance are easily improved.

### BRIEF DESCRIPTION OF DRAWINGS

FIG. 1 is a cross-sectional view showing an embodiment of a tire according to the present invention.

FIG. 2 is a cross-sectional view of a belt ply according to the present invention.

FIG. 3 is a cross-sectional view of a tread portion of the tire according to the present invention.

### MODE FOR CARRYING OUT INVENTION

An embodiment of the present invention will now be described in conjunction with accompanying drawings.

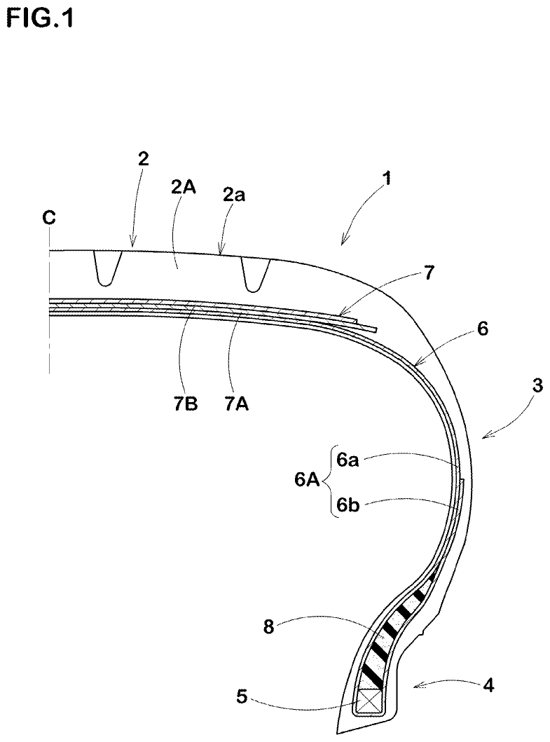

FIG. 1 shows a tire meridian section passing through a rotational axis of a tire 1 of the present embodiment in a standard state. The tire 1 of the present embodiment is suitably used as a pneumatic tire to be mounted on a passenger vehicle or the like. Note that the tire 1 is not specific to a pneumatic tire for passenger vehicles and can be applied to various tires such as, for example, pneumatic tires for heavy duty and non-pneumatic tires inside of which is not filled with pressurized air.

Here, the “standard state” is a state in which, in a case where the tire 1 is a pneumatic tire, the tire 1 is mounted on a standard rim, inflated to a standard inner pressure, and loaded with no tire load. In the following, the dimensions and so forth of each part of the tire 1 indicate values measured in this standard state, unless otherwise noted.

The “standard rim” is a wheel rim specified for the concerned tire by a standard included in a standardization system on which the tire is based, for example, the “normal wheel rim” in JATMA. “Design Rim” in TRA, and “Measuring Rim” in ETRTO.

The “standard inner pressure” is air pressure specified for the concerned tire by a standard included in a standardization system on which the tire is based, for example, the maximum air pressure in JATMA, maximum value listed in the “TIRE LOAD LIMITS AT VARIOUS COLD INFLATION PRESSURES” table in TRA, and “INFLATION PRESSURE” in ETRTO.

As shown in FIG. 1, the tire 1 of the present embodiment has a toroidal carcass 6 extending between bead cores 5 of bead portions 4 via a tread portion 2 and sidewall portions 3, and a belt layer 7 disposed outside the carcass 6 in a tire radial direction and inside the tread portion 2.

The tread portion 2 includes a tread rubber 2A.

The carcass 6 includes at least one carcass ply, one carcass ply 6A in the present embodiment. The carcass ply 6A includes carcass cords (not shown) disposed at an angle from 75 degrees to 90 degrees with respect to a tire circumferential direction, for example. As the carcass cords, organic fiber cords made of aromatic polyamide, rayon, or the like can be used, for example.

The carcass ply 6A includes, for example, a main body portion (6a) extending between the bead cores 5 of the bead portions 4 via the tread portion 2 and the sidewall portions 3 and turned up portions (6b) connected with the main body portion (6a) and each turned up around a respective one of the bead cores 5 from an inside to an outside in a tire axial direction. Between the main body portion (6a) and each of the turned up portions (6b) of the carcass ply 6A, a bead apex rubber 8 extending radially outward from a respective one of the bead cores 5 is disposed, for example.

The belt layer 7 includes at least one belt ply, two belt plies 7A and 7B in the present embodiment. The two belt plies 7A and 7B include a first belt ply 7A positioned on an inner side in the tire radial direction and a second belt ply 7B positioned outside the first belt ply 7A, for example. The belt layer 7 configured as such increases the rigidity of the tread portion 2, therefore, durability performance of the tire 1 can be improved. It should be noted that the belt layer 7 may be configured of three or more belt plies.

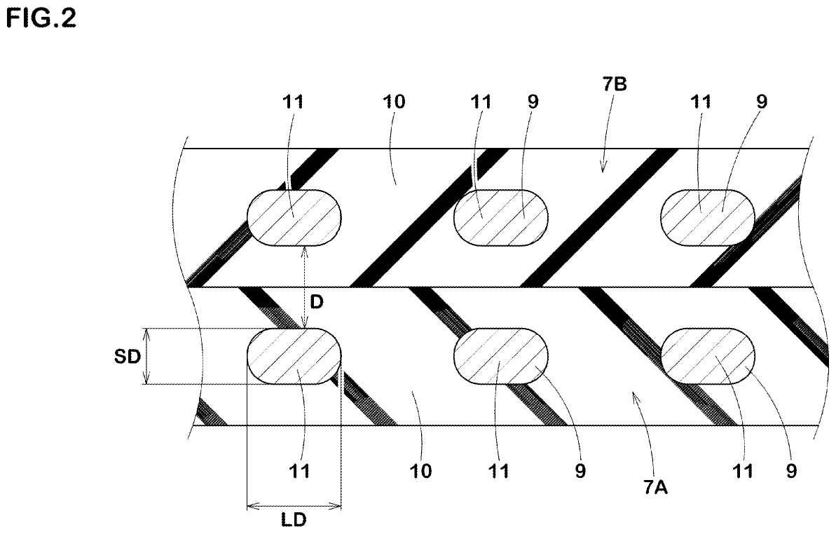

FIG. 2 is an enlarged cross-sectional view of the belt layer 7. While the belt ply 7A is exemplarily depicted in FIG. 2, a similar structure can be adopted also for the belt ply 7B. As shown in FIG. 2, at least one of the belt plies 7A and 7B of the present embodiment includes belt cords 9 for reinforcing the tread portion 2 and topping rubber 10 covering the belt cords 9. In the following, the belt cords 9 and the topping rubber 10 included in the belt ply 7A will be described, but the same applies to the belt cords 9 and the topping rubber 10 included in the belt ply 7B.

Each belt cord 9 is configured of a single-wire cord 11 not having a stranded structure. In the present embodiment, the single-wire steel cord 11 is used as the belt cord 9. The material of the belt cord 9 is not limited to steel and may be other metals or the like.

The single-wire cord 11 has a short diameter SD and a long diameter LD, and a ratio SD/LD between the short diameter SD and the long diameter LD is smaller than 1.00. That is, the cross-section of the belt cord 9 is formed in a flat shape. The cross-sectional shape of the single-wire cord 11 is not particularly limited as long as the flat shape is maintained. For example, the cross-sectional shape of the single-wire cord 11 may be an oval shape, as well as a long-oval shape having an end edge thereof being partially linear.

The single-wire cord 11 is disposed so that the direction of the short diameter SD is oriented to a thickness direction of the belt ply 7A. Therefore, the thickness of the belt ply 7A is suppressed while the sectional area of the belt cord 9 is maintained. Thereby, while the steering stability performance and the durability performance of the tire 1 are maintained, reduction in weight of the tire 1 can be achieved, and the fuel efficiency performance is improved. It should be noted that the orientation of the single-wire cords 11 is substantially maintained before and after vulcanization.

It is preferred that the topping rubber 10 after vulcanization has a complex elastic modulus (E*) of less than 7 MPa.

Here, the complex elastic modulus (E*) of the topping rubber 10 is a value measured in accordance with Japanese Industrial Standard JIS-K6394 under the following conditions by using a dynamic viscoelasticity measurement device (EPLEXOR series) manufactured by GABO.
Initial strain: 10%
Amplitude of dynamic strain: ±1%
Frequency: 10 Hz
Deformation mode: tension
Measurement temperature: 70 degrees Celsius

Due to the complex elastic modulus (E*) of the topping rubber 10 being less than 7 MPa, the bending rigidity of the belt ply 7A is suppressed, therefore, the noise performance and the ride comfort performance of the tire 1 are easily improved.

In view of the above, a more preferred range of the complex elastic modulus (E*) of the topping rubber 10 is 5 MPa or less.

It is preferred that the complex elastic modulus (E*) of the topping rubber 10 after vulcanization is 3 MPa or more. Since the complex elastic modulus (E*) of the topping rubber 10 being 3 MPa or more, the steering stability performance and the durability performance of the tire 1 are easily improved.

In the present embodiment, it is preferred that the short diameter SD of the single-wire cord 11 is from 0.15 mm to 0.42 mm. Since the short diameter SD is 0.15 mm or more, bending, breaking, or the like of the single-wire cord 11 in the process of manufacturing the belt ply 7A is easily suppressed. Further, the cross-sectional area of the single-wire cord 11 can be easily ensured, therefore, the durability performance of the tire 1 is easily improved. On the other hand, since the short diameter SD is 0.42 mm or less, the thickness of the belt ply 7A is suppressed, thereby, reduction in weight of the tire 1 is achieved, therefore, the fuel efficiency performance is improved.

In view of the above, a more preferred range of the short diameter SD of the single-wire cord 11 is from 0.20 mm to 0.35 mm.

In the present embodiment, it is preferred that the ratio SD/LD of the single-wire cord 11 is 0.70 or less. Since the ratio SD/LD is 0.70 or less, the thickness of the belt ply 7A is suppressed, thereby, reduction in weight of the tire 1 is achieved, therefore, the fuel efficiency performance is improved.

In view of the above, a more preferred range of the ratio SD/LD of the single-wire cord 11 is 0.50 or less.

In the present embodiment, it is preferred that a distance (D) between the single-wire cords 11 between the plurality of belt plies 7A and 7B is from 0.30 mm to 1.05 mm. The distance (D) is defined by, as shown in FIG. 2, the shortest distance between the single-wire cord 11 of the belt ply 7A and the single-wire cord 11 of the belt ply 7B, that is, the thickness of the topping rubber 10 existing therebetween.

Since the distance (D) is 0.30 mm or more, the ride comfort performance and the noise performance are easily improved. On the other hand, since the distance (D) is 1.05 mm or less, reduction in weight of the tire 1 can be easily achieved, therefore, the fuel efficiency performance is easily improved.

In view of the above, a more preferred range of the distance D is from 0.50 mm to 0.80 mm.

It is preferred that a difference (D-SD) between the distance (D) and the short diameter SD of the single-wire cord 11 is from 0.20 mm to 0.45 mm. Since the difference (D-SD) is 0.20 mm or more, the ride comfort performance and the noise performance are easily improved. On the other hand, since the above-described difference (D-SD) is 0.45 mm or less, the fuel efficiency performance is easily improved.

In view of the above, a more preferred range of the difference (D-SD) is 0.25 mm to 0.40 mm.

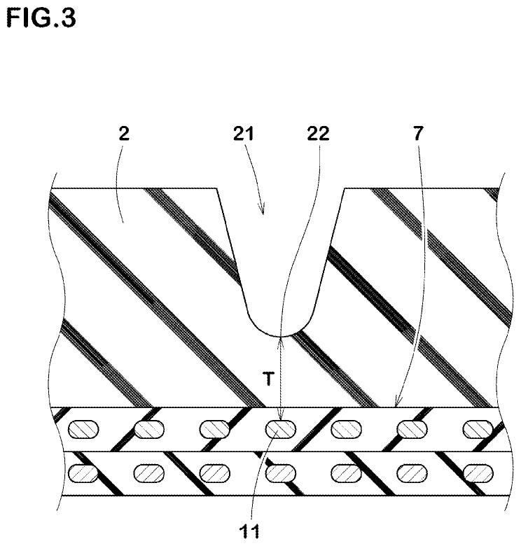

FIG. 3 shows an enlarged part of the tread portion 2. In an outer surface (2a) of the tread portion 2, a groove 21 is formed.

It is preferred that a minimum rubber thickness (T) from a bottom 22 of the groove 21 to the single-wire cord 11 is from 1.0 mm to 4.0 mm. Since the minimum rubber thickness (T) is 1.0 mm or more, the ride comfort performance and the noise performance are easily improved, and also damages on the tread portion 2 are suppressed. Since the minimum rubber thickness (T) is 4.0 mm or less, reduction in weight of the tire 1 can be easily achieved, therefore, the fuel efficiency performance is easily improved. Further, the rigidity of the tread portion 2 is easily increased and the steering stability performance is improved.

In view of the above, a more preferred range of the minimum rubber thickness (T) of the single-wire cord 11 is from 2.0 mm to 3.0 mm.

While detailed description has been made of an especially preferred embodiment of the present invention, the present invention can be embodied in various forms without being limited to the illustrated embodiment.

### EXAMPLES

Tires of size 195/65R15 having the tire meridian section of FIG. 1 were made by way of test according to the specifications of Table 1. By using the test tires, the steering stability performance, the ride comfort performance, the fuel-efficiency performance, and process passing property were evaluated. The test methods for each of the test tires were as follows.

<Steering Stability Performance>

While a test driver drove a front-wheel-drive small passenger test vehicle (displacement: 2000 cc) with the test tires mounted on all wheels on a test course of dry asphalt with the test driver being the only member on the test vehicle, characteristics related to steering responsiveness, rigid impression, grip, and the like were evaluated by the driver's feeling. The evaluations are indicated by an evaluation point based on Reference 1 being 100, wherein a larger numerical value is better.

<Ride Comfort Performance>

While the test driver drove the above-described test vehicle having the test tires mounted on all wheels on the test course with the test driver being the only member, the ride comfort performance was evaluated by the driver's feeling. The evaluations were indicated by an evaluation point based on Reference 1 being 100, wherein a larger numerical value is better.

<Fuel-Efficiency Performance>

Each of the test tires was mounted on a rolling resistance testing machine, inflated to the inner pressure of 230 kPa, and loaded with a tire load of 3.43 kN, and then rolling resistance at the speed of 80 km/h was measured. The results are indicated by an index based on Reference 1 being 100, wherein a larger numerical value indicates a smaller rolling resistance, which means more excellent fuel efficiency performance.

<Noise Performance>

Noise was measured while a test driver drove the above-described test vehicle with the test tires mounted on all wheels and the test driver being the only member on the test vehicle on a road noise measuring road. The results are indicated by an index based on Reference 1 being 100, wherein a larger numerical value indicates smaller noise, which means more excellent noise performance.

<Balance Performance>

An average value of the steering stability performance, the ride comfort performance, the fuel-efficiency performance, and the noise performance was calculated to evaluate balance performance. The results are indicated by a numerical value based on Reference 1 being 100, wherein a larger numerical value indicates more excellent balance performance.

<Durability Performance>

Each of the test tires was mounted on a bench durability testing machine and the running distance until the tire got damaged was measured. The results are indicated by an index based on Reference 1 being 100, wherein the larger the numerical value, the longer the running distance is, which means more excellent durability performance.

The test results are shown in Table 1.

TABLE 1

| | | Ref. 1 | Ref. 2 | Ref. 3 | Ex. 1 | Ex. 2 | Ex. 3 | Ex. 4 | Ex. 5 |
|---|---|---|---|---|---|---|---|---|---|
| Belt cord structure | | Stranded- | Single- | Single- | Single- | Single- | Single- | Single- | Single- |
| | | wire | wire | wire | wire | wire | wire | wire | wire |
| Belt cord configuration | | 1 × 2 × 0.295 | 1 × 1 × 0.42 | 1 × 1 | 1 × 1 | 1 × 1 | 1 × 1 | 1 × 1 | 1 × 1 |
| Short diameter SD | [mm] | 0.59 | 0.42 | 0.30 | 0.30 | 0.30 | 0.30 | 0.30 | 0.30 |
| Ratio SD/LD | | 1.00 | 1.00 | 0.61 | 0.61 | 0.61 | 0.61 | 0.61 | 0.61 |
| Complex elastic modulus (E*) | [MPa] | 6 | 8 | 8 | 4 | 2.5 | 3 | 5 | 7 |
| Distance (D) | [mm] | 0.70 | 0.70 | 0.70 | 0.70 | 0.70 | 0.70 | 0.70 | 0.70 |
| Thickness (T) | [mm] | 2.50 | 2.50 | 2.50 | 2.50 | 2.50 | 2.50 | 2.50 | 2.50 |
| Steering stability performance | [evaluation point] | 100 | 110 | 120 | 110 | 106 | 108 | 110 | 110 |
| Fuel efficiency performance | [index] | 100 | 115 | 115 | 110 | 106 | 108 | 110 | 115 |
| Ride comfort performance | [evaluation point] | 100 | 100 | 90 | 115 | 115 | 115 | 110 | 106 |
| Noise performance | [index] | 100 | 100 | 90 | 110 | 110 | 110 | 110 | 106 |
| Balance performance | [index] | 100 | 106.25 | 103.75 | 111.25 | 109.25 | 110.25 | 110 | 109.25 |
| Durability performance | [index] | 100 | 106 | 116 | 110 | 106 | 108 | 110 | 110 |

As is clear from Table 1, in the tires in Examples, compared with References, it has been confirmed that the steering stability performance, the ride comfort performance, the fuel-efficiency performance, the noise performance, and the durability performance are significantly improved in a good balance.

Tires of size 195/65R15 having the tire meridian section of FIG. 1 were made by way of test according to the specifications of Table 2. By using the test tires, the durability performance and the fuel-efficiency performance were evaluated. The test methods for each of the test tires were as follows.

<Durability Performance>

The durability performance was evaluated by the same method as described above. The results are indicated by an index based on Example 10 being 100, wherein a larger numerical value indicates more excellent durability performance.

<Fuel-Efficiency Performance>

The fuel-efficiency performance was evaluated by the same method as described above. The results are indicated by an index based on Example 10 being 100, wherein a larger numerical value indicates more excellent fuel-efficiency performance.

The test results are shown in Table 2.

TABLE 2

| | | Ex. 6 | Ex. 7 | Ex. 8 | Ex. 9 | Ex. 10 | Ex. 11 | Ex. 12 |
|---|---|---|---|---|---|---|---|---|
| Belt cord structure | | Single-wire | Single-wire | Single-wire | Single-wire | Single-wire | Single-wire | Single-wire |
| Belt cord configuration | | 1 × 1 | 1 × 1 | 1 × 1 | 1 × 1 | 1 × 1 | 1 × 1 | 1 × 1 |
| Short diameter SD | [mm] | 0.10 | 0.15 | 0.20 | 0.25 | 0.35 | 0.42 | 0.50 |
| Ratio SD/LD | | 0.20 | 0.31 | 0.40 | 0.50 | 0.70 | 0.85 | 1.02 |
| Complex elastic modulus (E*) | [MPa] | 4.4 | 4.4 | 4.4 | 4.4 | 4.4 | 4.4 | 4.4 |
| Distance (D) | [mm] | 0.70 | 0.70 | 0.70 | 0.70 | 0.70 | 0.70 | 0.70 |
| Thickness (T) | [mm] | 2.50 | 2.50 | 2.50 | 2.50 | 2.50 | 2.50 | 2.50 |
| Durability performance | [index] | 80 | 90 | 95 | 95 | 100 | 105 | 110 |
| Fuel efficiency performance | [index] | 100 | 100 | 100 | 100 | 100 | 98 | 96 |

Tires of size 195/65R15 having the tire meridian section of FIG. 1 were made by way of test according to the specifications of Table 3. By using the test tires, the steering stability performance, the ride comfort performance, the fuel-efficiency performance, the noise performance, the balance performance, and the durability performance were evaluated. The test methods for each of the test tires were as follows.

<Steering Stability Performance>

The steering stability performance was evaluated by the same method as described above. The results are indicated by an index based on Example 15 being 100, wherein a larger numerical value indicates more excellent steering stability performance.

<Ride Comfort Performance>

The ride comfort performance was evaluated by the same method as described above. The results are indicated by an index based on Example 15 being 100, wherein a larger numerical value indicates more excellent ride comfort performance.

<Fuel-Efficiency Performance>

The fuel-efficiency performance was evaluated by the same method as described above. The results are indicated by an index based on Example 15 being 100, wherein a larger numerical value indicates more excellent fuel-efficiency performance.

<Noise Performance>

Noise was measured by the same method as described above. The results are indicated by an index based on Example 15 being 100, wherein a larger numerical value means smaller noise, which indicates more excellent noise performance.

<Balance Performance>

An average value of the steering stability performance, the ride comfort performance, the fuel-efficiency performance, and the noise performance was calculated to evaluate the balance performance. The results are indicated by a numerical value based on Example 15 being 100, wherein a larger numerical value indicates more excellent balance performance.

<Durability Performance>

The durability performance was evaluated by the same method as described above. The results are indicated by an index based on Example 15 being 100, wherein a larger numerical value indicates more excellent durability performance.

The test results are shown in Table 3.

TABLE 3

| | | Ex. 13 | Ex. 14 | Ex. 15 | Ex. 16 | Ex. 17 | Ex. 18 |
|---|---|---|---|---|---|---|---|
| Belt cord structure | | Single-wire | Single-wire | Single-wire | Single-wire | Single-wire | Single-wire |
| Belt cord configuration | | 1 × 1 | 1 × 1 | 1 × 1 | 1 × 1 | 1 × 1 | 1 × 1 |
| Short diameter SD | [mm] | 0.30 | 0.30 | 0.30 | 0.30 | 0.30 | 0.30 |
| Ratio SD/LD | | 0.61 | 0.61 | 0.61 | 0.61 | 0.61 | 0.61 |
| Complex elastic modulus (E*) | [MPa] | 4.5 | 4.5 | 4.5 | 4.5 | 4.5 | 4.5 |
| Distance (D) | [mm] | 0.20 | 0.30 | 0.50 | 0.80 | 1.05 | 1.20 |
| Thickness (T) | [mm] | 2.50 | 2.50 | 2.50 | 2.50 | 2.50 | 2.50 |
| Steering stability performance | [evaluation point] | 106 | 103 | 100 | 97 | 95 | 90 |
| Fuel efficiency performance | [index] | 106 | 103 | 100 | 97 | 95 | 90 |
| Ride comfort performance | [evaluation point] | 90 | 95 | 100 | 102 | 103 | 106 |
| Noise performance | [index] | 90 | 95 | 100 | 102 | 103 | 106 |
| Balance performance | [index] | 98 | 99 | 100 | 99.5 | 99 | 98 |
| Durability performance | [index] | 98 | 99 | 100 | 100 | 99 | 98 |

Tires of size 195/65R15 having the tire meridian section of FIG. 1 were made by way of test according to the specifications of Table 4. By using the test tires, the steering stability performance, the ride comfort performance, the fuel-efficiency performance, the noise performance, the balance performance, and the durability performance were evaluated. The test methods for each of the test tires were as follows.

<Steering Stability Performance>

The steering stability performance was evaluated by the same method as described above. The results are indicated by an index based on Example 22 being 100, wherein a larger numerical value indicates more excellent steering stability performance.

<Ride Comfort Performance>

The ride comfort performance was evaluated by the same method as described above. The results are indicated by an index based on Example 22 being 100, wherein a larger numerical value indicates more excellent ride comfort performance.

<Fuel-Efficiency Performance>

The fuel-efficiency performance was evaluated by the same method as described above. The results are indicated by an index based on Example 22 being 100, wherein a larger numerical value indicates more excellent fuel-efficiency performance.

<Noise Performance>

Noise was measured by the same method as described above. The results are indicated by an index based on Example 22 being 100, wherein a larger numerical value means smaller noise, which indicates more excellent noise performance.

<Balance Performance>

An average value of the steering stability performance, the ride comfort performance, the fuel-efficiency performance, and the noise performance was calculated to evaluate the balance performance. The results are indicated by a numerical value based on Example 22 being 100, wherein a larger numerical value indicates more excellent balance performance.

<Durability Performance>

The durability performance was evaluated by the same method as described above. The results are indicated by an index based on Example 22 being 100, wherein a larger numerical value indicates more excellent durability performance.

The test results are shown in Table 4.

TABLE 4

| | | Ex. 19 | Ex. 20 | Ex. 21 | Ex. 22 | Ex. 23 | Ex. 24 |
|---|---|---|---|---|---|---|---|
| Belt cord structure | | Single-wire | Single-wire | Single-wire | Single-wire | Single-wire | Single-wire |
| Belt cord configuration | | 1 × 1 | 1 × 1 | 1 × 1 | 1 × 1 | 1 × 1 | 1 × 1 |
| Short diameter SD | [mm] | 0.30 | 0.30 | 0.30 | 0.30 | 0.30 | 0.30 |
| Ratio SD/LD | | 0.61 | 0.61 | 0.61 | 0.61 | 0.61 | 0.61 |
| Complex elastic modulus (E*) | [MPa] | 4.6 | 4.6 | 4.6 | 4.6 | 4.6 | 4.6 |
| Distance (D) | [mm] | 0.40 | 0.50 | 0.55 | 0.70 | 0.75 | 0.85 |
| Difference (D − SD) | [mm] | 0.10 | 0.20 | 0.25 | 0.40 | 0.45 | 0.55 |
| Thickness (T) | [mm] | 2.50 | 2.50 | 2.50 | 2.50 | 2.50 | 2.50 |
| Steering stability performance | [evaluation point] | 108 | 106 | 100 | 100 | 97 | 95 |
| Fuel efficiency performance | [index] | 108 | 106 | 100 | 100 | 97 | 95 |
| Ride comfort performance | [evaluation point] | 86 | 90 | 100 | 100 | 102 | 103 |
| Noise performance | [index] | 86 | 90 | 100 | 100 | 102 | 103 |
| Balance performance | [index] | 97 | 98 | 100 | 100 | 99.5 | 99 |
| Durability performance | [index] | 97 | 98 | 100 | 100 | 100 | 99 |

Tires of size 195/65R15 having the tire meridian section of FIG. 1 were made by way of test according to the specifications of Table 5. By using the test tires, the steering stability performance, the ride comfort performance, the fuel-efficiency performance, the noise performance, the balance performance, and tire strength were evaluated. The test methods for each of the test tires were as follows.

<Steering Stability Performance>

The steering stability performance was evaluated by the same method as described above. The results are indicated by an index based on Example 28 being 100, wherein a larger numerical value indicates more excellent steering stability performance.

<Ride Comfort Performance>

The ride comfort performance was evaluated by the same method as described above. The results are indicated by an index based on Example 28 being 100, wherein a larger numerical value indicates more excellent ride comfort performance.

<Fuel-Efficiency Performance>

The fuel-efficiency performance was evaluated by the same method as described above. The results are indicated by an index based on Example 28 being 100, wherein a larger numerical value indicates more excellent fuel-efficiency performance.

<Noise Performance>

Noise was measured by the same method as described above. The results are indicated by an index based on Example 28 being 100, wherein a larger numerical value indicates more excellent noise performance.

<Balance Performance>

An average value of the steering stability performance, the ride comfort performance, the fuel-efficiency performance, and the noise performance was calculated to evaluate the balance performance. The results are indicated by a numerical value based on Example 28 being 100, wherein a larger numerical value indicates more excellent balance performance.

<Tire Strength>

The test tires were poked with a protruding object and the energy required to burst the tires was measured. The results are indicated by an index based on Example 28 being 100, wherein a larger numerical value indicates larger energy, which means high tire strength.

The test results are shown in Table 5.

TABLE 5

| | | Ex. 25 | Ex. 26 | Ex. 27 | Ex. 28 | Ex. 29 | Ex. 30 |
|---|---|---|---|---|---|---|---|
| Belt cord structure | | Single-wire | Single-wire | Single-wire | Single-wire | Single-wire | Single-wire |
| Belt cord configuration | | 1 × 1 | 1 × 1 | 1 × 1 | 1 × 1 | 1 × 1 | 1 × 1 |
| Short diameter SD | [mm] | 0.30 | 0.30 | 0.30 | 0.30 | 0.30 | 0.30 |
| Ratio SD/LD | | 0.61 | 0.61 | 0.61 | 0.61 | 0.61 | 0.61 |
| Complex elastic modulus (E*) | [MPa] | 4.7 | 4.7 | 4.7 | 4.7 | 4.7 | 4.7 |
| Distance (D) | [mm] | 0.90 | 1.30 | 2.30 | 3.30 | 4.30 | 5.30 |
| Thickness (T) | [mm] | 0.60 | 1.00 | 2.00 | 3.00 | 4.00 | 5.00 |
| Steering stability performance | [evaluation point] | 106 | 103 | 100 | 100 | 95 | 90 |
| Fuel efficiency performance | [index] | 106 | 103 | 100 | 100 | 95 | 90 |
| Ride comfort performance | [evaluation point] | 90 | 95 | 100 | 100 | 103 | 106 |
| Noise performance | [index] | 94 | 96 | 100 | 100 | 103 | 106 |
| Balance performance | [index] | 99 | 99.3 | 100 | 100 | 99 | 98 |
| Tire strength | [index] | 80 | 90 | 100 | 100 | 105 | 110 |

### DESCRIPTION OF REFERENCE SIGNS

1 tire
2 tread portion
2A tread rubber
2a outer surface
7 belt layer
7A belt ply
7B belt ply
10 topping rubber
11 single-wire cord
21 groove
22 bottom
D distance
LD long diameter
SD short diameter
T minimum rubber thickness

1. A tire having a belt layer disposed inside a tread portion, wherein the belt layer includes at least one belt ply,
the at least one belt ply includes a single-wire cord having a short diameter SD and a long diameter LD, with a ratio SD/LD between the short diameter SD and the long diameter LD being less than 1.00, and a topping rubber covering the single-wire cord, the single-wire cord is arranged so that a direction of the short diameter SD is oriented to a thickness direction of the at least one belt ply, and
the topping rubber has a complex elastic modulus (E*) of less than 7 MPa under conditions of temperature of 70 degrees Celsius, initial strain of 10%, an amplitude of dynamic strain of ±1.0%, and a frequency of 10 Hz.

2. The tire according to claim 1, wherein the complex elastic modulus (E*) is 5 MPa or less.

3. The tire according to claim 1, wherein the complex elastic modulus (E*) is 3 MPa or more.

4. The tire according to claim 1, wherein the short diameter SD is 0.15 mm to 0.42 mm.

5. The tire according to claim 4, wherein the short diameter SD is 0.20 mm to 0.35 mm.

6. The tire according to claim 1, wherein the ratio SD/LD of the single-wire cord is 0.70 or less.

7. The tire according to claim 6, wherein the ratio SD/LD of the single-wire cord is 0.50 or less.

8. The tire according to claim 1, wherein the belt layer has a plurality of the belt plies.

9. The tire according to claim 8, wherein a distance D between the single-wire cords between the plurality of the belt plies is 0.30 mm to 1.05 mm.

10. The tire according to claim 9, wherein the distance D is 0.50 mm to 0.80 mm.

11. The tire according to claim 10, wherein a difference D-SD between the distance D and the short diameter SD is 0.20 mm to 0.45 mm.

12. The tire according to claim 11, wherein the difference D-SD is 0.25 mm to 0.40 mm.

13. The tire according to claim 1, wherein
the tread portion has a tread rubber having a groove provided in an outer surface thereof, and
a minimum rubber thickness from a bottom of the groove to the single-wire cord is 1.0 mm to 4.0 mm.

14. The tire according to claim 13, wherein the minimum rubber thickness is 2.0 mm to 3.0 mm.
